(19) United States
(12) Patent Application Publication
(10) Pub. No.: US 2016/0003666 A1
(43) Pub. Date: Jan. 7, 2016

(54) METHOD AND SYSTEM FOR FILTERING NOISE OF LIQUID LEVEL MEASUREMENTS FROM A RESERVOIR

(71) Applicant: Titan Logix Corp, Edmonton (CA)

(72) Inventors: Sean PATTERSON, Edmonton (CA); Nolan SERINK, Edmonton (CA); Ron WILLIS, Edmonton (CA); Greg MCGILLIS, Edmonton (CA)

(21) Appl. No.: 14/791,347

(22) Filed: Jul. 3, 2015

Related U.S. Application Data
(60) Provisional application No. 62/021,060, filed on Jul. 4, 2014.

(30) Foreign Application Priority Data
Jul. 4, 2014 (CA) 2855761

(51) Int. Cl. G01F 25/00; G01F 23/00

(52) U.S. Cl. CPC G01F 25/0061; G01F 23/0061

(57) ABSTRACT

The method generally has the steps of: measuring a measured liquid level value in a reservoir; generating a filtered liquid level value including applying a first noise filtration stage to the measured liquid level value to limit the change of the filtered liquid level value compared to previous liquid level value measurements; determining a variation of the generated filtered liquid level value over a given period of time; comparing the determined variation to a threshold value; when the determined variation is above the threshold value, entering a sloshing mode, the sloshing mode including generating an outputted liquid level value corresponding to a filtered liquid level value generated prior to entering the sloshing mode, the sloshing mode being maintained until the determined variation is below the threshold value; and when the determined variation is below the threshold value, generating an outputted liquid level value corresponding to the filtered liquid level value.

### CROSS-REFERENCE TO RELATED APPLICATIONS

This application claims priority and the benefit of U.S. Provisional Application No. 62/021,060 and Canadian Application No. 2,855,761, both entitled METHOD AND SYSTEM FOR FILTERING NOISE OF LIQUID LEVEL MEASUREMENTS FROM A RESERVOIR, both filed on Jul. 4, 2014. These applications are hereby incorporated by reference in their entireties.

### FIELD

The improvements generally relate to the field of measuring a liquid level of a reservoir, and more particularly to the field of addressing the effect of sloshing in such liquid level measurements.

### BACKGROUND

Measuring a liquid level in a reservoir is typically performed using a liquid level sensor provided inside the reservoir and immersed in the liquid. While reliable liquid level measurements can be obtained in some conditions, occurrences of sloshing led to unreliable liquid level measurements. In a mobile reservoir, such as a liquid reservoir of a deicing truck for instance, movement of the reservoir can lead to sloshing of the liquid within the reservoir. Sloshing can also occur in a fixed reservoir, such as when liquid is filed in and/or extracted from the reservoir at a relatively high flow rate. When sloshing occurred inside the reservoir, the value of liquid which was displayed to the user varied significantly and was not representative of the actual liquid level in the reservoir for a given period of time.

There thus remained room for improvement, particularly in terms of addressing the effect of sloshing in the measurements of a liquid level in a reservoir.

### SUMMARY

In accordance with one aspect, there is provided a method for outputting a liquid level value, the method comprising the steps of: measuring a measured liquid level value in the reservoir; generating a filtered liquid level value including applying a noise filtration stage to the measured liquid level value to limit a change of the filtered liquid level value compared to at least one previously measured liquid level value; determining a variation of the generated filtered liquid level value over a given period of time; comparing the determined variation to a threshold value; when the determined variation is below the threshold value, processing the liquid level value in a non-sloshing mode including outputting a liquid level value corresponding to the filtered liquid level value; and when the determined variation is above the threshold value, processing the liquid level value in a sloshing mode including outputting a liquid level value corresponding to a filtered liquid level value generated prior to entering the sloshing mode.

In accordance with another aspect, there is provided a method for filtering noise in liquid level measurements of a reservoir, the method comprising the steps of: measuring a measured liquid level value indicative of a liquid level in the reservoir at a given point in time; estimating a liquid level value in the reservoir at the given point in time, said estimation being based on the measured liquid level value at the given point in time and on at least one liquid level value measured before the given point in time; obtaining a deviation value by comparing the measured liquid level value to the estimated liquid level value; obtaining a number of noisy deviation values by comparing an amount of the previously obtained deviation values to a noise threshold value; and outputting a noise-reduced liquid level value, the noise-reduced liquid level value corresponding to the estimated value when the number of noisy deviation values is below a noise limit and to a previously outputted liquid level value when the number of noisy deviation values is above the noise limit.

In accordance with another aspect, there is provided a system for outputting a liquid level value in a reservoir having a liquid level sensor therein, the system comprising: a computer being adapted to receive a measured liquid level value from the liquid level sensor, the measured liquid level value being indicative of a liquid level in the reservoir at a given point in time, wherein the computer is adapted to: apply a first noise filtration stage to the measured liquid level value, the first noise filtration stage including estimating a liquid level value in the reservoir at the given point in time, said estimation being based on the measured liquid level value at the given point in time and on at least one liquid level value measured before the given point in time; apply a second noise filtration stage including obtaining a deviation value by comparing the measured liquid level value to the estimated liquid level value; obtaining a number of noisy deviation values by comparing an amount of the previously obtained deviation values to a noise threshold value; and outputting a noise-reduced liquid level value corresponding to the estimated value when the number of noisy deviation values is below a noise limit and to a previously outputted liquid level value when the number of noisy deviation values is above the noise limit; and a display being adapted to receive the outputted noise-reduced liquid level value from the computer and being adapted to display the outputted noise-reduced liquid level value.

In accordance with another aspect, there is provided a method for filtering noise in liquid level measurements of a reservoir, the method comprising the steps of: measuring one of a plurality of measured liquid level values indicative of a liquid level in the reservoir at a corresponding time; estimating the one of the plurality of measured liquid level values to obtain one of a plurality of estimated liquid level values being indicative of the liquid level in the reservoir at the corresponding time, said estimation being based at least on a preceding one of the plurality of measured liquid level values; obtaining one of a plurality of deviation values by comparing the one of the plurality of the measured liquid level values to the one of the plurality of estimated liquid level values; obtaining a number of noisy deviation values by comparing an amount of the previously obtained deviation values to a noise threshold value; and outputting one of a plurality of filtered liquid level values being indicative of a noise-reduced liquid level in the reservoir at the corresponding time, the outputted one of the plurality of filtered values being one of the one of the plurality of estimated values when the number of noisy deviation values is below a noise limit or the preceding outputted one of the plurality of filtered liquid level values when the number of noisy deviation values is above the noise limit.

Many further features and combinations thereof concerning the present improvements will appear to those skilled in the art following a reading of the instant disclosure.

### DESCRIPTION OF THE FIGURES

In the figures,

FIG. 1 is a simplified flow chart of an example of a method for filtering noise in liquid level measurements of a reservoir;

FIG. 2 is a graph showing a first example of measured and filtered liquid levels;

FIG. 3 is a graph showing a second example of measured and filtered liquid levels;

FIG. 4 is a block diagram showing an example of a system for filtering noise in liquid level measurements of a reservoir; and

FIG. 5 is a flow chart of an example of a method for filtering noise in liquid level measurements of a reservoir.

### DETAILED DESCRIPTION

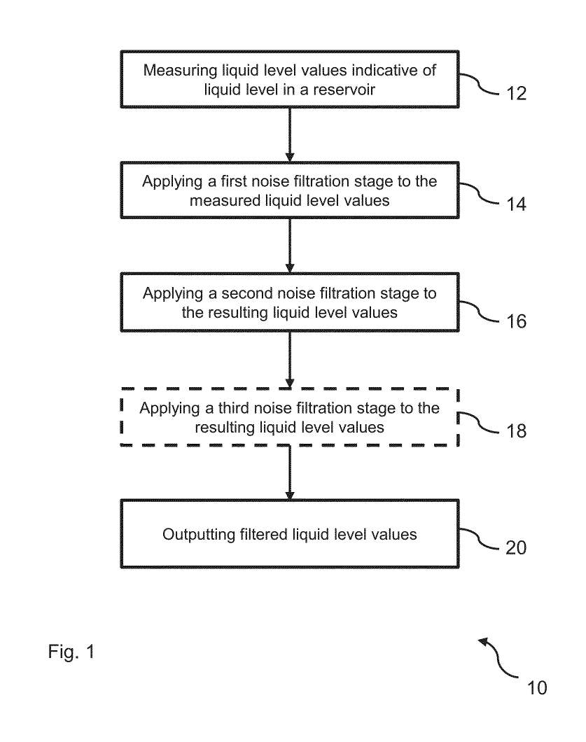

FIG. 1 shows a block diagram of an example of a method 10 for filtering noise in liquid level measurements (measured at step 12) of a reservoir. The method 10 for filtering noise includes two noise filtration steps 14, 16 (or stages) and can also include an optional third noise filtration step 18. In this example, the first step is used to filter out noise (high frequency fluctuations) which can be caused by the liquid level sensor itself. The second step is used to determine whether there is an occurrence of sloshing or not, and can address an occurrence of sloshing by locking the liquid level value which is displayed to the user to a value which was processed prior to the occurrence of sloshing. Detailed description of these stages will now be provided below, with reference to specific embodiments, beginning with the first noise filtration stage 14.

In one embodiment, the first noise filtration stage 14 estimates the fluctuation of liquid level inside the reservoir thus obtaining an estimated liquid level value representative of the measured liquid level value in the reservoir. The first noise filtration stage 14 is based at least on previous measured liquid level and limits how the estimated liquid level value is allowed to change within a period of time. More specifically, the first noise filtration stage 14 limits the change of the estimated liquid level value compared to previous liquid level value measurements. This allowed change can vary depending on the application. Therefore, the allowed change can be greater for applications wherein the liquid level value change during the period of time is expected to be important and, conversely, will be smaller for applications wherein the liquid level value change during the period of time is expected to be less important.

This filtration stage 14 can be based on a mathematical model modelling how the liquid level can vary inside the reservoir, but it can also be based on the previously measured liquid level values, on estimated liquid level values, as well as on initial parameters. For instance, the estimated liquid value can be a previous estimated liquid value to which is added a period of time multiplied by a flow rate. Accordingly, if a reservoir operator pumps liquid out of the reservoir at a rate of 0.5 liters per second, and a measurement is taken each 0.1 s, then the estimated liquid level value can be the previous estimated liquid level value minus 0.5 liters per second times 0.1 s, i.e. minus 0.05 liters. The instantaneous flow rate of the pump can optionally be used in the estimation of the liquid level value. While this particular mathematical model is described herein, other state models can also be used along with the method for filtering noise in liquid level measurements in a reservoir.

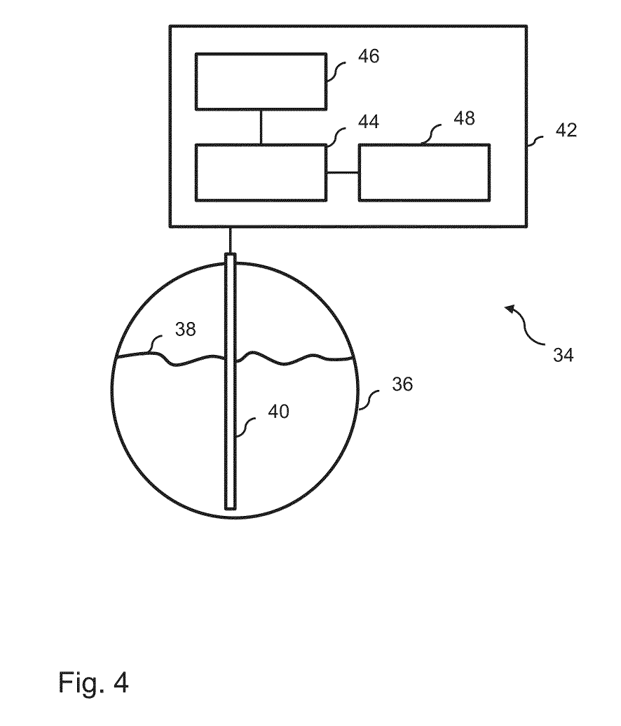

Moreover, the first noise filtration stage 14 can estimate the measured liquid level values using a moving average filter provided in simple, cumulative and/or weighted forms, Linear Quadratic Estimation (LQE) such as a Kalman filter (as will be described below) or other suitable filters, for instance. In the embodiment presented in FIG. 4, the Kalman filter was found to be suitable as the first noise filtration stage 14. Indeed, a parameter Q of the Kalman filter can be adjusted depending on the application. The parameter Q can be associated to the rate at which the estimated liquid level values converge towards the measured liquid level values or to the weighting of the previously estimated liquid level values compared to the measured liquid level values. With a higher parameter Q, the estimated liquid level values follow the measured liquid level values more rapidly than with a lower parameter Q. In other words, the weighting of the previously measured liquid level value is higher with a higher Q than with a lower Q. Conversely, the weighting of the previously estimated liquid level value is lower with a higher Q than with a lower Q. For instance, in an example where the estimated liquid level value is estimated using a constant flow rate (F) state model, e.g. MLLᵢ=MLLᵢ₋₁+dT*F, the Kalman filter may be given by the following equations:

ELLᵢ=ELLᵢ₋₁+K_{Li}*(M_{LLi}−ELLᵢ₋₁) (1)

K_{Li}=P_{Li}/(P_{Li}+R_{T}) (2)

P_{Li}=P_{Li-1}*(1−K_{Li-1})+2*dT*P_{LFi-1}+dT²*P_{Fi-1}+dT³*Q/3 (3)

P_{LFi}=P_{LFi-1}*(1−K_{Li-1})+dT*P_{Fi-1}+dT²*Q/2 (4)

P_{Fi}=P_{Fi-1}−K_{Fi}*(P_{LFi}−1)+dT²*Q (5)

K_{Fi}=P_{LFi}/(P_{Li}+R_{T}) (6)

where MLLᵢ is the measured liquid level value for iteration i, ELLᵢ is the estimated liquid level value for iteration i, dT is the difference of time between two consecutive liquid level value measurements, F is the flow rate indicative of the flow entering/exiting the reservoir, the parameter Q, K_{L}, R_{T} and P_{L} are adjustable parameters of the Kalman filter. In an example involving a state model different from the constant flow rate state model, the Kalman filter may be given by a different set of equations, for instance. Moreover, in some applications, the algorithm can adjust the parameter Q dynamically.

Once the measured liquid level value is estimated, a step of applying a second noise filtration stage 16 to the resulting estimated liquid level value is performed. In this second noise filtration stage 16, the estimated liquid level value is analyzed in order to determine if the current measured liquid level is in a sloshing mode or not in a sloshing mode. To do so, for instance, a variation of the estimated liquid level value over a given period of time is determined and compared to a threshold value. If the variation is below the threshold value, the estimated liquid level value will be outputted as the filtered liquid level value at step 20. However, if the variation is above the threshold value, the liquid in the reservoir is considered to be in the sloshing mode, i.e. a mode in which the sloshing noise value is evaluated to be important relative to the liquid level value. Therefore, a previously outputted filtered liquid level value will be repeatedly outputted as the filtered liquid level value until the determined variation is below the threshold value at the step 20.

Optionally, when the liquid in the reservoir is considered to be in the sloshing mode, the allowed change between the estimated liquid level value compared to previous liquid level value measurements during the first noise filtration stage can be increased. Therefore, while the outputted filtered liquid level value is a previously outputted filtered liquid level value, the first noise filtration stage is modified to allow for faster converging in order to reduce the time required for the determined variation to be reduced below the threshold value. Accordingly, in a situation where a reservoir operator monitors the outputted filtered liquid level value when the liquid is considered to be in the sloshing mode, he/she will observe the same repeated outputted filtered liquid level value for as long as the liquid is identified as being in the sloshing mode. However, in the background, the first noise filtration stage 14 is modified to converge to the measured liquid level values within a shorter amount of time.

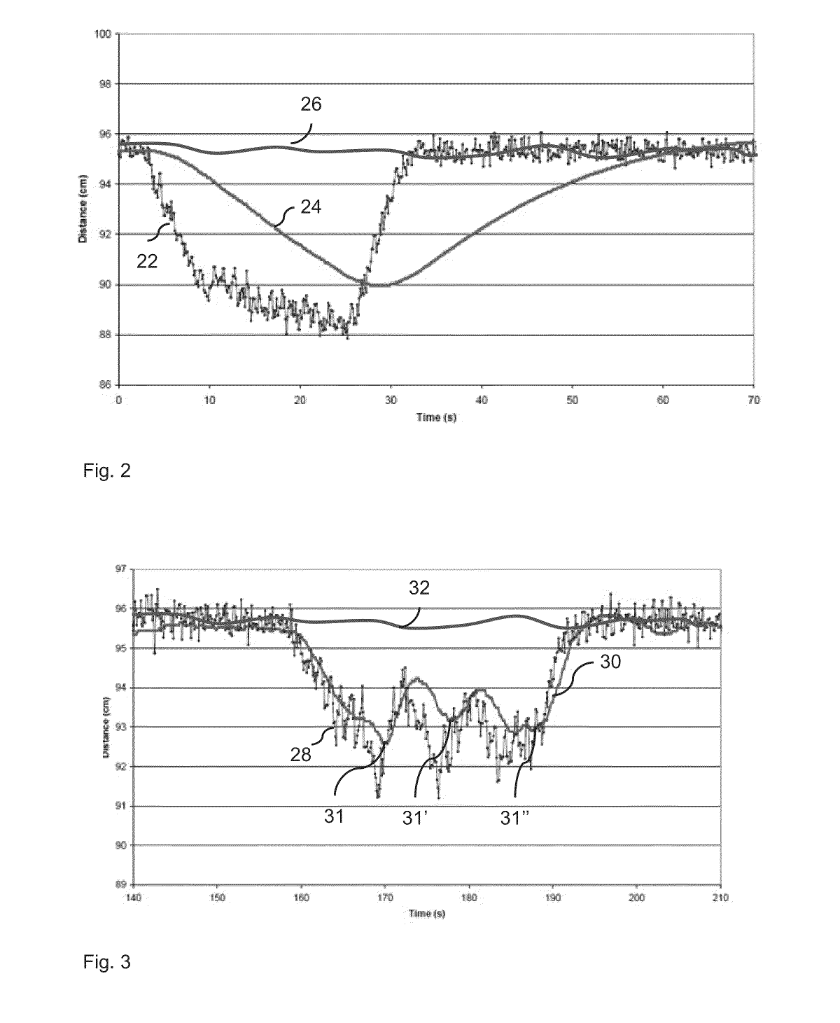

FIG. 2 is a graph showing a measured liquid level 22 (line and dots) and filtered liquid levels 24 and 26 (solid line and dashed line). In this example, the filtered liquid level 24 (solid line) has an allowed change, between the estimated liquid level values compared to previous liquid level value measurements, which is kept low. Therefore, the filtered liquid level values converge towards the measured liquid level values slowly, thus generating a delay between a measured sloshing event and a filtered sloshing event. In this example, the threshold value of the filtered liquid level 24 (solid line) may be larger than what would be required to compensate for the measured sloshing event. Indeed, the filtered liquid level 26 (dashed line) has a smaller threshold value, therefore the second stage 16 flagged a sloshing mode and the first and second noise filtration stages 14, 16 acted one with the other in order to output a filtered liquid level value of 95.5 cm from 0 to 70 seconds thus compensating for the sloshing event.

FIG. 3 is a graph showing a measured liquid level 28 (line and dots) and filtered liquid levels 30 and 32 (solid line and dashed line). In this example, the filtered liquid level 30 (solid line) was processed using a first noise filtration stage which allows for a relatively high change between the estimated liquid level value compared to previous liquid level value measurements. Therefore, the filtered liquid level values can follow the measured liquid level values rapidly, thus avoiding the delay illustrated in FIG. 2 as well as outputting a filtered liquid level which includes fast-varying variations 31, 31′ and 31″ such as can be induced by sloshing. The estimated liquid level 32 (dashed line) has a smaller threshold value, therefore the sloshing mode is identified early during the measurements which contributed to output a filtered liquid level value of 95.5 cm from 140 to 210 seconds.

Referring back to FIG. 1, the method has an optional third noise filtration stage 18 which can be implemented to the first and second noise filtration stages 14 and 16. In this embodiment, the third noise filtration stage 18 is a clipping filter which outputs a previously outputted filtered liquid level value when a difference between a filtered liquid level value and the previously outputted filtered liquid level value is smaller than a clipping threshold. This third optional noise filtration stage 18 can therefore avoid small fluctuations and thus simplify the reading of the outputted estimated liquid level value as seen from a reservoir operator, for instance.

The method for filtering noise in liquid level measurements can be implemented using either a measured liquid level which is sampled with an acquisition module having a sampling frequency or with an analog liquid level detector (not shown). In this latter situation, the determined variation may be an integral of the variation over a given period of time, for instance. Such a mathematical operation can be implemented in a printed circuit board (PCB) using electrical components such as op-amps and resistors interacting one with another to process the analog signal adequately.

FIG. 4 is a block diagram showing an example of a system 34 for filtering noise in liquid level measurements of a reservoir 36. In this example, the system 34 includes the reservoir 36 into which liquid 38 is disposed. The liquid 38 is free to move inside the reservoir, which can lead to sloshing. The system 34 also includes a liquid level sensor 40 being adapted to measure a liquid level value indicative of the liquid level inside the reservoir 36. In this embodiment, liquid level sensor 40 illustrated is a guided wave radar (GWR) fluid level gauge, though it will be understood that any alternate suitable liquid level sensor can be used. In this example, the liquid level sensor 40 is connected to a computer 42 having a processor 44, a memory 46 and a display 48. The connection between the liquid level sensor 40 and the computer 42 can be wired or wireless, for instance. In another example, the computer 42 may be mounted on an exterior portion of the liquid level sensor 40, for instance, such that the display 48 can be seen directly by a user standing outside the reservoir 36. Alternatively, the computer 42 may be in wireless communication with the liquid level sensor 40 and disposed at a remote location therefrom. In still another example, the components of the computer 42 can be remotely disposed from one another. For instance, the processor 44 and the memory 46 may be mounted to the exterior portion of the liquid level sensor 40 while the display 48 is disposed at a remote location therefrom. The computer 42 is adapted to apply successively the first and second noise filtration stages 14 and 16 described above, and can optionally be adapted to apply the third filtration stage 18. In an alternate embodiment, more than one computer can be used to perform corresponding stages.

More specifically, in the illustrated embodiment, the computer 42 is adapted to receive a measured liquid level value from the liquid level sensor wherein the measured liquid level value is indicative of a liquid level in the reservoir 36 at a given point in time. In this example, the computer 42 is adapted to apply the first noise filtration stage 14 to the measured liquid level value, wherein the first noise filtration stage 14 includes estimating a liquid level value in the reservoir 36 at the given point in time. The step of estimating is based on the measured liquid level value at the given point in time, on at least one liquid level value measured before the given point in time and on a converging rate. Once the first noise filtration stage 14 is performed, the computer 42 is adapted to apply the second noise filtration stage 16 which includes obtaining a deviation value by comparing the measured liquid level value to the estimated liquid level value; obtaining a number of noisy deviation values by comparing an amount of the previously obtained deviation values to a noise threshold value; and outputting, on the display 48 of the computer 42, a noise-reduced liquid level value corresponding to the estimated value when the number of noisy deviation values is below a noise limit and to a previously outputted liquid level value when the number of noisy deviation values is above the noise limit. Optionally, the computer 42 is further adapted to apply the first noise filtration stage 14 while allowing the converging rate to be increased when a previous number of noisy deviation values is above the noise limit. Moreover, the computer 42 is further adapted to apply the third noise filtration stage 18 which includes maintaining the outputted filtered liquid level value to a prior outputted filtered liquid level value when the difference between the two successive outputted liquid level values is smaller than a clipping threshold. For instance, the noise filtration stages can be provided in the form of a single software, or more than one software, which is(are) stored on the memory 46 and executed by the processor 44. Alternatively, it is noted that either one of the noise filtration stages can be performed by a corresponding electrical circuit mounted on a PCB. In another example, the second and third noise filtration stage is performed using two independent parts of a single software while the first noise filtration stage is performed using an electric circuit integrating a Kalman filter or other suitable noise filter via corresponding electronic components.

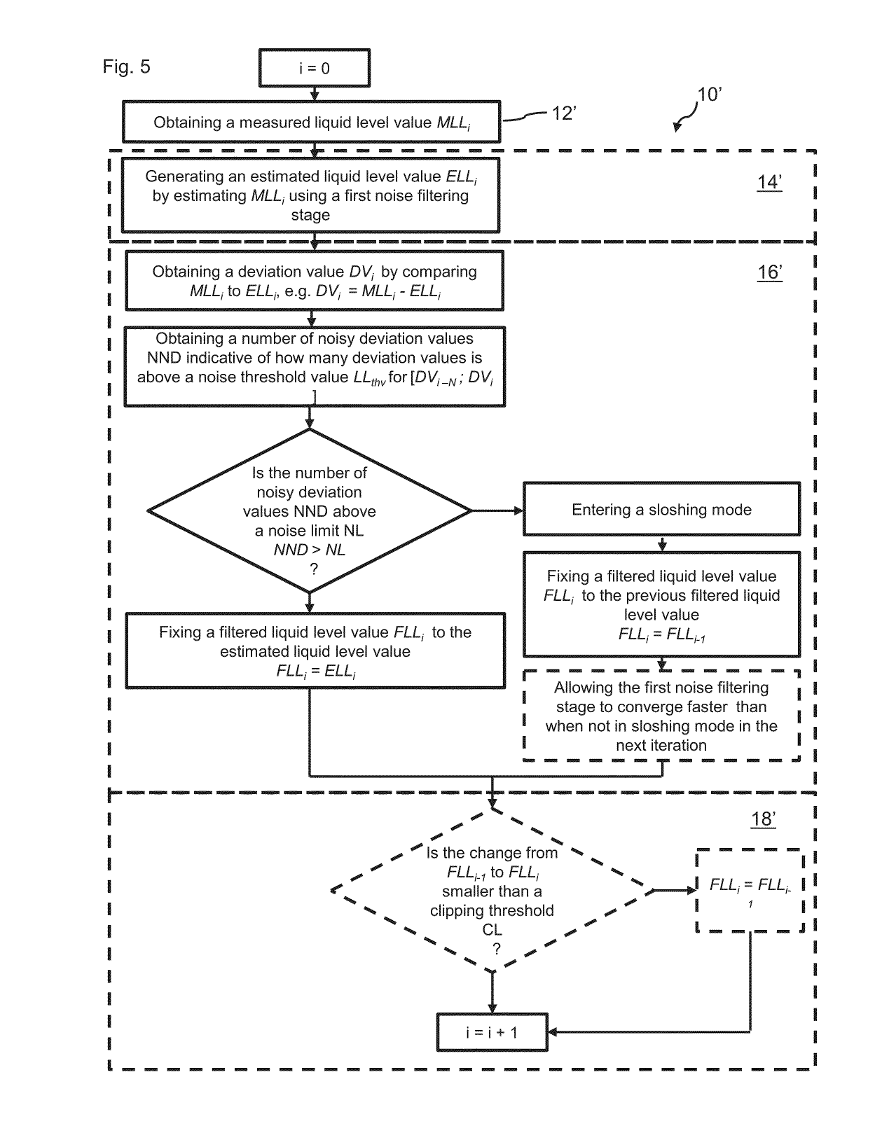

FIG. 5 is a flow chart of an example of a method 10′ for filtering noise in liquid level measurements of a reservoir. In this example, the method 10′ is to be applied iteratively on measured liquid values which are sampled over time. Accordingly, a measured liquid level value MLL for iteration i is designated as MLLᵢ, an estimated liquid level value for iteration i is designated as ELLᵢ, a deviation value DV for iteration i is designated as DVᵢ, a number of noisy deviation values is designated as NND, a noise threshold value is designated as LLₜₕ, a noise limit is designated as NL, an outputted filtered liquid level value for iteration i is designated as FLLᵢ, and a clipping threshold CL.

In this example, the algorithm starts at iteration zero (i=0) and is performed repeatedly for all the measured liquid level values. For instance, the analysis of the seventh iteration is presented here below (i=7). First, the measured liquid level value MLL₇ indicative of a liquid level in the reservoir at the corresponding time t₇ is obtained. Then, the measured liquid level value MLL₇ is estimated to obtain the estimated liquid level value ELL₇ being indicative of the liquid level in the reservoir at the corresponding time t₇ also. The estimation can be based on MLL₆, for instance, and optionally on a converging rate. It is to be noted that the estimation can be based on a plurality of previous MLLᵢ as well as on a plurality of previous ELLᵢ. Still in this example, the second noise filtration stage 16′ includes computing a deviation value DV₇ by subtracting the estimated liquid level value ELL₇ from the measured liquid level value MLL₇. Then, a number of noisy deviation values NN_{D} is obtained by comparing an amount of the previously obtained deviation values, say DV₃ to DV₇, to the threshold value LLₜₕ. If DV₃, DV₄, DV₅, DV₆ and DV₇ are above the threshold value LLₜₕ, then the number of noisy deviation values NND is five. In this example, the liquid level is considered to be in a sloshing mode when the number of noisy deviation is above the noise limit NL. For instance, if the noise limit NL is ten, then the liquid level is not considered to be in the sloshing mode. However, if the noise limit NL is four then the liquid level is considered to be in the sloshing mode. When the liquid level is not in the sloshing mode, the filtered liquid level value FLL₇ is fixed to the estimated liquid level value ELL₇, therefore FLL₇=ELL₇. However, when the liquid level is in the sloshing mode, the filtered liquid level value FLL₇ is fixed to the previous filtered liquid level value FLL₆, therefore FLL₇=FLL₆. In this situation, the converging rate of the first noise filtration stage can be increased for the eighth iteration in order the reduce the amount of time required to exit the sloshing mode. The converging rate can be changed, for instance, by taking more measurements in a predetermined period of time or also by increasing the allowed change of liquid level value between two successive estimated liquid level values. Finally, the last and optional third noise filtration stage 18′ acts on the filtered liquid level value FLL₇ and determines if the change between FLL₇ and FLL₆ is high enough, i.e. higher than the clipping threshold CL, to be outputted to the user. The flow chart ends with i=i+1, which indicates that the flow chart is iterative and that the steps are to be performed for the following iteration, say the eight iteration in this case.

As can be understood, the examples described above and illustrated are intended to be exemplary only. For instance, instead of being processed iteratively, the first stage filtration can be performed in real time, such as by using electronic components to form the filter rather than a computer. The scope is indicated by the appended claims.

What is claimed is:

1. A method for filtering noise in liquid level measurements of a reservoir, the method comprising the steps of:
measuring a measured liquid level value indicative of a liquid level in the reservoir at a given point in time;
estimating a liquid level value in the reservoir at the given point in time, said estimation being based on the measured liquid level value at the given point in time and on at least one liquid level value measured before the given point in time;
obtaining a deviation value by comparing the measured liquid level value to the estimated liquid level value;
obtaining a number of noisy deviation values by comparing an amount of the previously obtained deviation values to a noise threshold value; and
outputting a noise-reduced liquid level value, the noise-reduced liquid level value corresponding to the estimated value when the number of noisy deviation values is below a noise limit and to a previously outputted liquid level value when the number of noisy deviation values is above the noise limit.

2. The method of claim 1, wherein said estimation is further based on a converging rate, and wherein said step of estimating further comprises allowing the converging rate to be increased when a previous number of noisy deviation values is above the noise limit.

3. The method of claim 1 further comprising maintaining the outputted filtered liquid level value to a prior outputted filtered liquid level value when the difference between the two successive outputted liquid level values is smaller than a clipping threshold.

4. A method of outputting a liquid level value indicative of a liquid level in a reservoir, the method comprising the steps of:
measuring a measured liquid level value in the reservoir;
generating a filtered liquid level value including applying a noise filtration stage to the measured liquid level value to limit a change of the filtered liquid level value compared to at least one previously measured liquid level value;
determining a variation of the generated filtered liquid level value over a given period of time;
comparing the determined variation to a threshold value;
when the determined variation is below the threshold value, processing the liquid level value in a non-sloshing mode including outputting a liquid level value corresponding to the filtered liquid level value; and
when the determined variation is above the threshold value, processing the liquid level value in a sloshing mode including outputting a liquid level value corresponding to a filtered liquid level value generated prior to entering the sloshing mode.

5. The method of claim 4, wherein said sloshing mode processing includes applying the noise filtration stage in a manner to limit the change of the filtered liquid level value to a lesser extent than during said non-sloshing mode processing.

6. The method of claim 4 further comprising maintaining the outputted liquid level value to a prior outputted liquid level value when the difference between the two liquid level values is smaller than a clipping threshold.

7. A system for outputting a liquid level value in a reservoir having a liquid level sensor therein, the system comprising:
a computer being adapted to receive a measured liquid level value from the liquid level sensor, the measured liquid level value being indicative of a liquid level in the reservoir at a given point in time, wherein the computer is adapted to:
apply a first noise filtration stage to the measured liquid level value, the first noise filtration stage including estimating a liquid level value in the reservoir at the given point in time, said estimation being based on the measured liquid level value at the given point in time and on at least one liquid level value measured before the given point in time;
apply a second noise filtration stage including obtaining a deviation value by comparing the measured liquid level value to the estimated liquid level value; obtaining a number of noisy deviation values by comparing an amount of the previously obtained deviation values to a noise threshold value; and outputting a noise-reduced liquid level value corresponding to the estimated value when the number of noisy deviation values is below a noise limit and to a previously outputted liquid level value when the number of noisy deviation values is above the noise limit; and
a display being adapted to receive the outputted noise-reduced liquid level value from the computer and being adapted to display the outputted noise-reduced liquid level value.

8. The system of claim 7, wherein the first noise filtration stage is further based on a converging rate, and wherein the computer is further adapted to apply the first noise filtration stage while allowing the converging rate to be increased when a previous number of noisy deviation values is above the noise limit.

9. The system of claim 7, wherein the computer is further adapted to apply a third noise filtration stage including maintaining the outputted filtered liquid level value to a prior outputted filtered liquid level value when the difference between the two successive outputted liquid level values is smaller than a clipping threshold.
